(19) United States
(12) Patent Application Publication
(10) Pub. No.: US 2008/0314212 A1
(43) Pub. Date: Dec. 25, 2008

(54) Tool holding module

(75) Inventor: Peter Chen, Taoyuan County (TW)

Correspondence Address: Joe McKinney Muncy, PO Box 1364, Fairfax, VA, 22038-1364, US

(73) Assignee: PRIMETOOL MFG, INC.

(21) Appl. No.: 11/812,735

(22) Filed: Jun. 21, 2007

(51) Int. Cl. B23B 29/04

(52) U.S. Cl. 82/157

(57) ABSTRACT

The present invention discloses a tool holding module, wherein a hollow fixture seat and a hollow tool rod are integrated to form a holding module. A fixture head is arranged in the front of the fixture seat and enfolded by the tool rod, whereby the tool holding module of the present invention becomes more secure and robust and can maintain the concentricity between the fixture seat and the tool rod. Therefore, the present invention can prevent a tool from vibration, damage or falling off caused by insufficient concentricity or coupling force resulting from too great a length of the tool rod and can thus increase the machining precision and service life. Besides, the prevent invention also provides various assembly interfaces for different fixture seats and tool rods.

### FIELD OF THE INVENTION

The present invention relates to a tool holding module, particularly to a tool holding module which can promote machining stability.

### BACKGROUND OF THE INVENTION

At present, high-precision metal machining, such as drilling, reaming, boring, thread milling, inner/outer diameter drilling, or surface grinding, is usually processed by a CNC (Computer Numerical Control) machining table together with various cutters or tools. A cutter or tool has a long handle gripped by a gripper or a grip mechanism, whereby the cutter or tool can be coupled to a driving shaft of a CNC table. Thus, the driving shaft rotating at a high speed can drive the cutter or tool gripped by a gripper to machine a target workpiece.

A R.O.C. patent No. M253434 disclosed a “Detachable Tool Fixture”, which comprises a tool rod, a grip member and a fixing member. The tool rod has a coned hole extending inward along the axis from one end thereof with its diameter gradually contracting from the rim to the interior. The grip member has a cone portion at one end thereof and a sleeved portion at the other end. The tilt angle of the cone portion is identical to that of the coned hole. The cone portion is arranged inside the coned hole. The sleeved portion has a central hole fixing a tool with a heating method. The fixing member sleeves the grip member and is coupled to the tool rod with a screwing method, and the grip member is thus secured to the tool rod. The objective of the conventional technology is to utilize a single tool rod to grip different-specification tools. However, the conventional technology still has some problems. In the conventional technology, the fixing member is used to sleeve the grip member and coupled to the end of the tool rod with a screwing method to enhance the coupling between the grip member and the tool rod; thus, the user has to rotate the fixing member in assembling or disassembling, which inconveniences the user.

### SUMMARY OF THE INVENTION

The primary objective of the present invention is to provide a tool holding module, which increases machining stability via improving the coupling force and concentricity between the fixture seat and the tool rod and can thus prevent a tool from damage or losing precision when the tool is machining a target metal.

To achieve the abovementioned objective, the present invention proposes a tool holding module, wherein a hollow fixture seat and a hollow tool rod are integrated to form a holding module. A fixture head is arranged in the front of the fixture seat and enfolded by the tool rod, whereby the tool holding module of the present invention becomes more secure and robust and can maintain the concentricity between the fixture seat and the tool rod. Therefore, the present invention can prevent the tool from vibration, damage, or falling off and can thus increase machining precision and service life. Besides, the prevent invention also provides various assembly interfaces for different fixture seats and tool rods.

### BRIEF DESCRIPTION OF THE DRAWINGS

FIG. 1 is a perspective exploded view schematically showing the tool holding module according to one embodiment of the present invention.

FIG. 2 is a sectional view schematically showing the tool holding module according to one embodiment of the present invention.

FIG. 3 is a perspective exploded view schematically showing the tool holding module according to another embodiment of the present invention.

FIG. 4 is a sectional view schematically showing the tool holding module according to another embodiment of the present invention.

FIG. 5 is a perspective exploded view schematically showing the tool holding module according to further another embodiment of the present invention.

FIG. 6 is a sectional view schematically showing the tool holding module according to further another embodiment of the present invention.

### DETAILED DESCRIPTION OF THE PREFERRED EMBODIMENTS

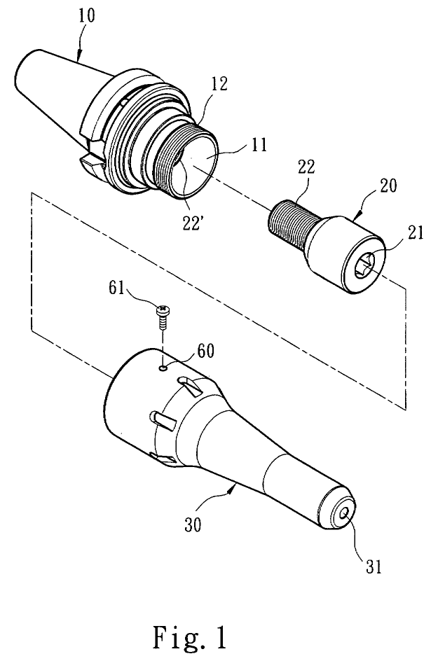

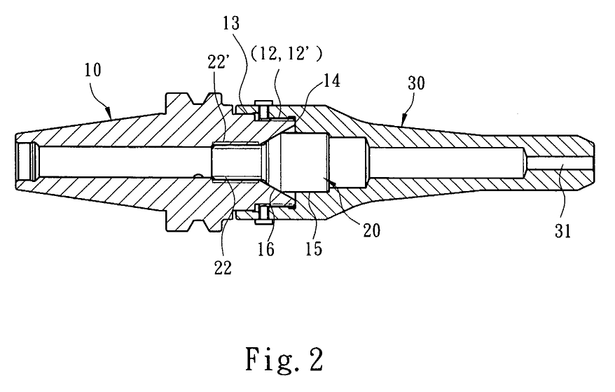

Below, the technical contents of the present invention are described in detail in cooperation with the drawings. Refer to FIG. 1 and FIG. 2 respectively a perspective exploded view and a sectional view schematically showing the tool holding module according to one embodiment of the present invention. The present invention is integrated with a driving shaft (not shown in the drawings) and is used to couple a machining cutter or tool to a machining table (not shown in the drawings), wherein the driving shaft of the machining table drives the machining cutter or tool to rotate at a high speed and machine a target workpiece (not shown in the drawings). The tool holding module of the present invention comprises a fixture seat 10 and a tool rod 30. An about pillar-like fixture head 20 is arranged at the connection region of the fixture seat 10 and the tool rod 30. The fixture head 20 is accommodated in a first accommodation room 11 of the fixture seat 10 and enfolded by the tool rod 30. The fixture seat 10 is tightly coupled to the fixture head 20 via first connection members 22 and 22′ and is tightly coupled to the tool rod 30 via second connection members 12 and 12′. The fixture seat 10, the fixture head 20 and the tool rod 30 are tightly coupled at the contact interfaces 13, 14, 15, and 16, and the fixture head 20 is enfolded by the tool rod 30. Thereby, the tool holding module of the present invention becomes more secure and robust and can maintain the concentricity between the fixture seat 10 and the tool rod 30, which can avoid the detachment of the tool rod 30 from the fixture seat 10 and can prevent from the machining precision degradation caused by the tool loosening resulting from insufficient concentricity or coupling force.

The fixture head 20 may have an auxiliary installation hole 21; an appropriate instrument (not shown in the drawings) may be inserted into the auxiliary installation hole 21 to assist in installing the fixture head 20 into the first accommodation room 11 of the fixture seat 10. The first connection members 22 and 22′/the second connection members 12 and 12′ may be a pair of threads matching each other. The second connection member 12 and 12′ may have at least one tapped hole 60, and a screw bolt 61 can be screwed into the tapped hole 60 to enhance the coupling security between the fixture seat 10 and the tool rod 30. The fixture seat 10, the fixture head 20 and the tool rod 30 are all hollow, and an installation tunnel 31 is formed thereinside; and a cutter or tool is inserted into the installation tunnel 31 for installation. The length by which the cutter or tool emerges from the tool holding module can be regulated via adjusting the length by which the cutter or tool is inserted into the installation tunnel 31.

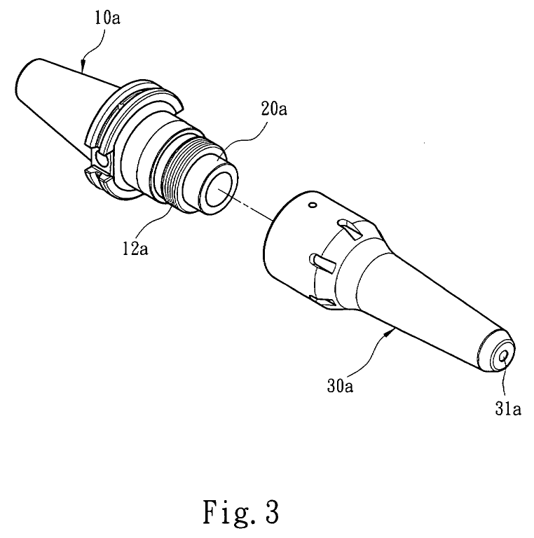

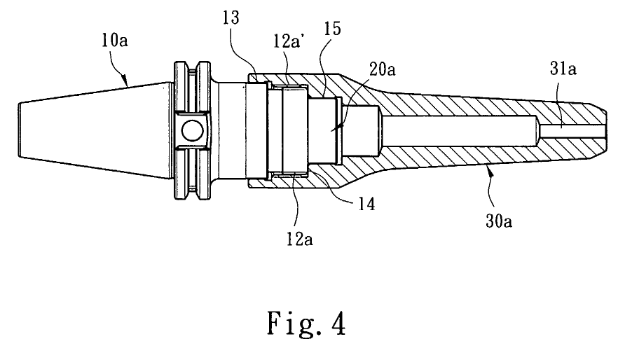

Refer to FIG. 3 and FIG. 4 respectively a perspective exploded view and a sectional view schematically showing the tool holding module according to another embodiment of the present invention. Distinct from the embodiment mentioned above, this embodiment has a fixture seat 10a and a fixture head 20a, which are fabricated into a one-piece component, whereby the time to install the fixture head 20a into the fixture seat 10a is saved. The fixture seat 10a can be directly and tightly coupled to a tool rod 30a via connecting the second connection member 12a and 12a′; thereby, the fixture head 20a will be enfolded by the tool rod 30a, and a secure and robust structure of the tool holding module is thus achieved. Then, an installation tunnel 31a is formed thereinside to install a cutter or tool.

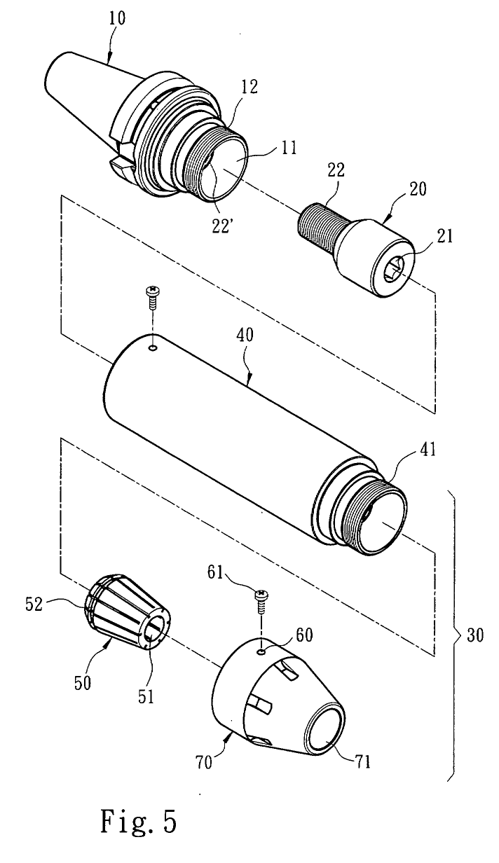

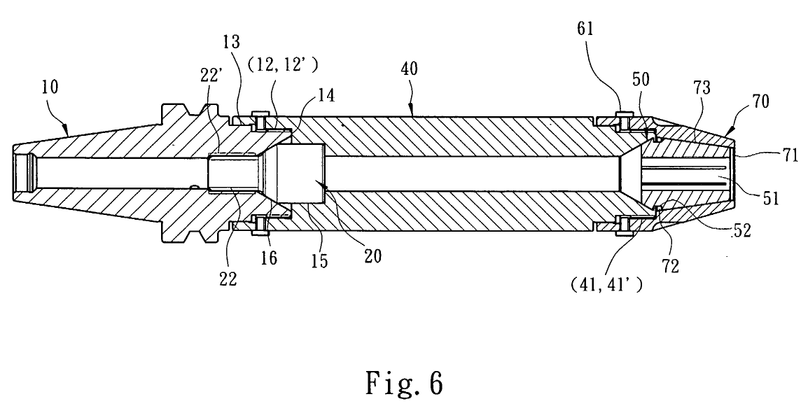

Refer to FIG. 5 and FIG. 6 respectively a perspective exploded view and a sectional view schematically showing the tool holding module according to further another embodiment of the present invention. As shown in FIG. 5 and FIG. 6, in this embodiment, the tool rod 30 further comprises an extension rod 40, a grip member 50 and a nut 70. The fixture seat 10 is tightly coupled to the fixture head 20 via the first connection members 22 and 22′ and is tightly coupled to one end of the extension rod 40 via the second connection members 12 and 12′; thus, the extension rod 40 enfolds the fixture head 20 thereinside. The grip member 50 is accommodated inside a second accommodation room 73 of the nut 70. The grip force of the grip member 50 is enhanced via the cooperation of an annular trench 52 of the grip member 50 and an annular fixing member 72 of the nut 70. The grip member 50 has a plurality of claw plates periodically and annularly arranged to form a cone-like claw structure 51. The other end of the extension rod 40 is tightly coupled to the nut 70 via third connection members 41 and 41′. Thus, the grip member 50 is tightly secured thereinside, and the extension rod 40 is fixedly installed between the fixture seat 10 and the nut 70.

The third connection members 41 and 41′ may also be a pair of threads matching each other and have at least one tapped hole 60, and a screw bolt 61 can be screwed into the tapped hole 60 to enhance the coupling security between the extension rod 40 and the nut 30. The fixture seat 10, the fixture head 20, the extension rod 40, the grip member 50 and the nut 70 are all hollow, and an installation tunnel 71 is formed thereinside, and a cutter or tool is inserted into the installation tunnel 71 for installation. The length by which a cutter or tool emerges from the tool holding module can be regulated via adjusting the length by which the cutter or tool is inserted into the installation tunnel 71. Then, the cutter or tool is fixed by the grip member 50. The cone-like claw structure 51 provides the grip member 50 with the flexibility to hold different-specification cutters or tools. When a cutter or tool is inserted into the cone-like claw structure 51, the inner diameter of the cone-like claw structure 51 can be adjusted appropriately to meet the cutter or tool. After the grip member 50 is coupled to the extension rod 40, the claw structure 51 will contract inward and grip the cutter or tool tightly while the nut 70 is coupled to the extension rod 40, which can prevent the cutter or tool from loosening at a high rotation speed. The cutter or tool is tightly gripped by the grip member 50, and only a small portion of the cutter or tool is exposed outside; therefore, the influence of external force is reduced, and the machining precision is greatly promoted when the cutter or tool machines a target workpiece.

Those described above are only the preferred embodiments to exemplify the present invention but not to limit the scope of the present invention. Any equivalent modification or variation according to the spirit of the present invention is to be also included within the scope of the present invention.

What is claimed is:

1. A tool holding module comprising:
a fixture seat having a fixture head arranged at one end thereof, and
a tool rod coupled to said fixture seat and enfolding said fixture head.

2. The tool holding module according to claim 1, wherein said fixture seat and said fixture head are fabricated into a one-piece component.

3. The tool holding module according to claim 1, wherein said fixture head may have an auxiliary installation hole.

4. The tool holding module according to claim 1, wherein said fixture seat is tightly coupled to said fixture head via first connection members.

5. The tool holding module according to claim 4, wherein said first connection members is a pair of threads matching each other.

6. The tool holding module according to claim 1, wherein said fixture seat is tightly coupled to said tool rod via second connection members.

7. The tool holding module according to claim 6, wherein said second connection members is a pair of threads matching each other.

8. The tool holding module according to claim 6, wherein said second connection members have at least one through tapped hole, and at least one screw bolt can be screwed into said through tapped hole.

9. The tool holding module according to claim 1, wherein said tool rod further comprises an extension rod, a grip member and a nut.

10. The tool holding module according to claim 9, wherein said extension rod is coupled to said nut via third connection members.

11. The tool holding module according to claim 10, wherein said third connection members is a pair of threads matching each other.

12. The tool holding module according to claim 10, wherein said third connection members have at least one tapped hole, and at least one screw bolt can be screwed into said tapped hole.

13. The tool holding module according to claim 9, wherein said grip member is arranged in a second accommodation room of said nut.

14. The tool holding module according to claim 9, wherein said grip member has a plurality of claw plates periodically and annularly arranged to form a cone-like claw structure.

15. The tool holding module according to claim 9, wherein said nut has an annular fixing member, and said grip member has an annular trench corresponding to said fixing member.
